(19) United States
(12) Patent Application Publication
(10) Pub. No.: US 2002/0076295 A1
(43) Pub. Date: Jun. 20, 2002

(54) Torque limiting device

(76) Inventor: Rodney Gibbons, Markham (CA)

Correspondence Address: Arne I. Fors, Gowling Lafleur Henderson LLP, Suite 4900, Commerce Court West, Toronto, ON, M5L 1J3, CA

(21) Appl. No.: 09/735,475

(22) Filed: Dec. 14, 2000

(51) Int. Cl. F16B 31/00

(52) U.S. Cl. 411/1

(57) ABSTRACT

There is provided a torque limiting device to be used in screw fasteners. The device comprises a torquing head defining an internally threaded bore. The torquing head further defines an upper collar having a greater outer diameter than its lower section which section is adapted to receive a hexagonal nut thereover. A laser weld, functioning as a shearing element interconnects the torquing head and the hexagonal nut.

### BACKGROUND OF THE INVENTION

(i) Field of the Invention

The present invention relates to a torque limiting device utilizing laser welds to provide the precise torque shear value thereto. More specifically, the torque limiting device is an interconnected two component nut assembly.

(ii) Description of the Related Art

The application of a correct or precise torque during the assembly of certain mechanical components, such as screw fasteners, is essential to their mechanical integrity. Devices used to achieve accurate torquing, such as torque limiters and torque wrenches are known and are used in the assembly of, for example, the securement of engine heads onto automotive engine blocks. The object of such torque limiting devices and wrenches is to provide uniform torquing of nuts onto bolts, studs or the like without under torquing or over torquing the fastener with the resultant mechanical failure thereof.

Problems exist with the prior art tools and systems in that they contain movable parts which are breakable, are expensive, require re-calibration or, for the amateur mechanic, often are not conveniently available when required.

In U.S. Pat. No. 3,191,486 issued to R. P. Gibbens, there are disclosed automatic torque indicating and applying devices. Of particular relevance are the automatic torque indicating nut assemblies depicted in FIGS. 1 to 5 therein. There is disclosed a torquing head releasably connected to a lower hexagonal member. The lower hexagonal member (i.e. a nut) defines a lower outwardly extending hexagonally shaped flange narrowing at its upper end into a cylindrical shank which is internally threaded. A shear pin positioned between suitable bores extends through the torquing head into the cylindrical shank of the lower hexagonal member. Thus, by using several shear pins various values of torque can be automatically indicated or applied.

R. Gibbons in U.S. Pat. No. 5,927,917 describes a tamper-proof, precision, torque limiting nut device. The device, assembled, comprises an inner collar member having a threaded bore adapted to receive a bolt, stud or the like and an outer sleeve member interconnected to the collar by pins or welds having a shear strength up to a predetermined torque shear value. The longitudinal axis of the collar and sleeve are substantially equal. Over torquing and under torquing are prevented, and tampering with the nut is substantially obviated.

### SUMMARY OF THE INVENTION

It is a primary objective of the present invention to provide a simple and inexpensive torque limiting device, used as part of a screw fastener, which can be torqued to a precise predetermined shear value utilizing a simple wrench or the like thereby avoiding under or over torquing thereof. Furthermore, in the event that removal of the screw fastener may be necessitated for maintenance or other purposes, the torque limiting device of the invention permits facile removal thereof and replacement by a conventional screw fastener.

It is a secondary objective to provide a torque limiting device which may be more easily and rapidly installed on assembly lines in the automotive industry and related applications.

It is yet a further objective to provide a torque limiting device which may be installed from either direction.

There is provided a torque limiting device adapted for use with a fastener which comprises a torquing head defining an internally threaded, longitudinal bore coaxial therewith, said bore being adapted to receive said fastener therein. The torquing head forms at its one end a collar having a greater outer diameter than its opposite end, thereby defining a circumferential lip therebetween. A hexagonal nut having a smooth inner bore coaxial therewith is adapted to engage and receive the opposite end of the torquing head having a narrower outer diameter therein. Thus, a face of the hexagonal nut lies in abutment with the circumferential lip and the collar extends beyond the hexagonal nut permitting the removal of the torque limiting device because the collar may be gripped by a wrench or vise. Means for shearing the connection between the torquing head and the hexagonal nut at a precise torque shear value are provided. Such shearing means are further adapted to interconnect the torquing head and hexagonal nut prior to installation of the torque limiting device. The shear means comprises at least two laser welds interconnecting at least a portion of an area of the hexagonal nut with at least a portion of an adjacent of the torquing head whereby said laser welds are functional to shear at a predetermined torque shear strength, thereby eliminating both under and over torquing of said torque limiting device. Preferably, two diametrically opposed laser welds or three or more equi spaced laser welds are used.

### BRIEF DESCRIPTION OF THE DRAWINGS

Preferred embodiments of the present invention will now be described, by way of example only, having reference to the accompanying drawings, in which:

FIG. 1 is an exploded perspective view of a first embodiment of the torque limiting device in accordance with the present invention;

FIG. 2 is an exploded perspective view of a second embodiment of the torque limiting device in accordance with the present invention;

FIG. 3 is an exploded perspective view of the torque limiting device of FIG. 1 illustrating the placement thereof with respect to a fastener member;

FIG. 4 is a side elevation of the assembled torque limiting device of FIG. 1;

FIG. 5 is a side elevation of the assembled torque limiting device of FIG. 2;

FIG. 6 is a longitudinal section of the assembled torque limiting device shown in FIGS. 1 and 2;

FIG. 7 shows a top plan view of the assembled torque limiting device shown in FIG. 1;

FIG. 8 depicts an isometric view of the assembled torque limiting device shown in FIG. 1;

FIG. 9 is a perspective view of a third embodiment of an assembled torque limiting device of the present invention;

FIG. 10 is a perspective view of a fourth embodiment of an assembled torque limiting device of the instant application; and

FIG. 11 is an isometric view of the assembled torque limiting device of FIG. 9.

### DESCRIPTION OF THE PREFERRED EMBODIMENT

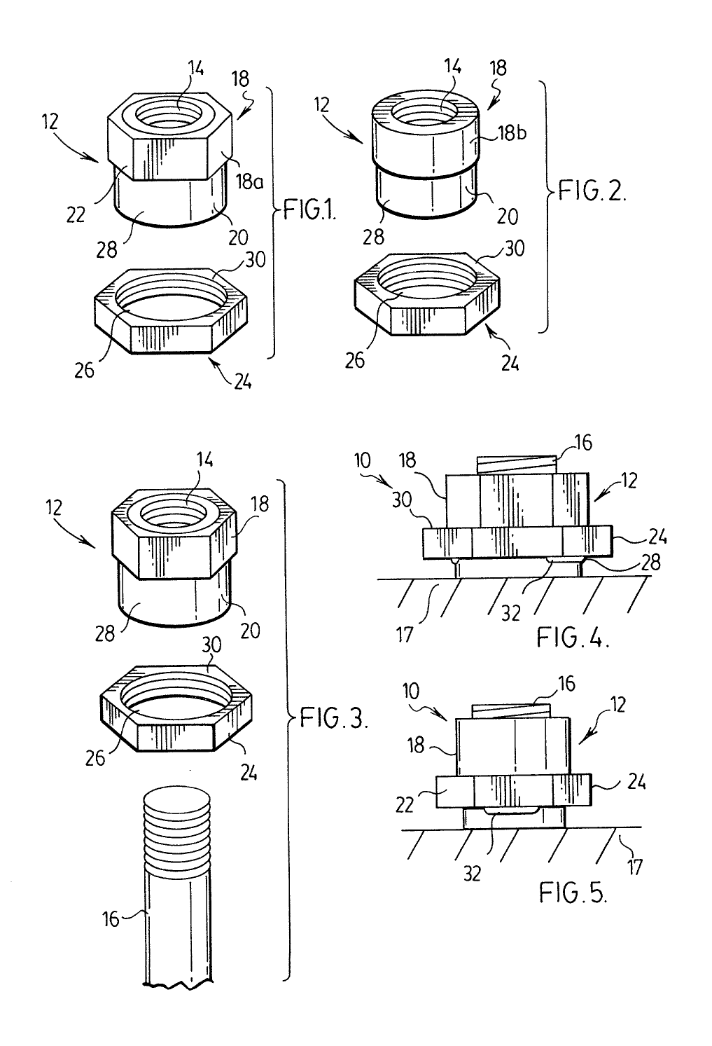

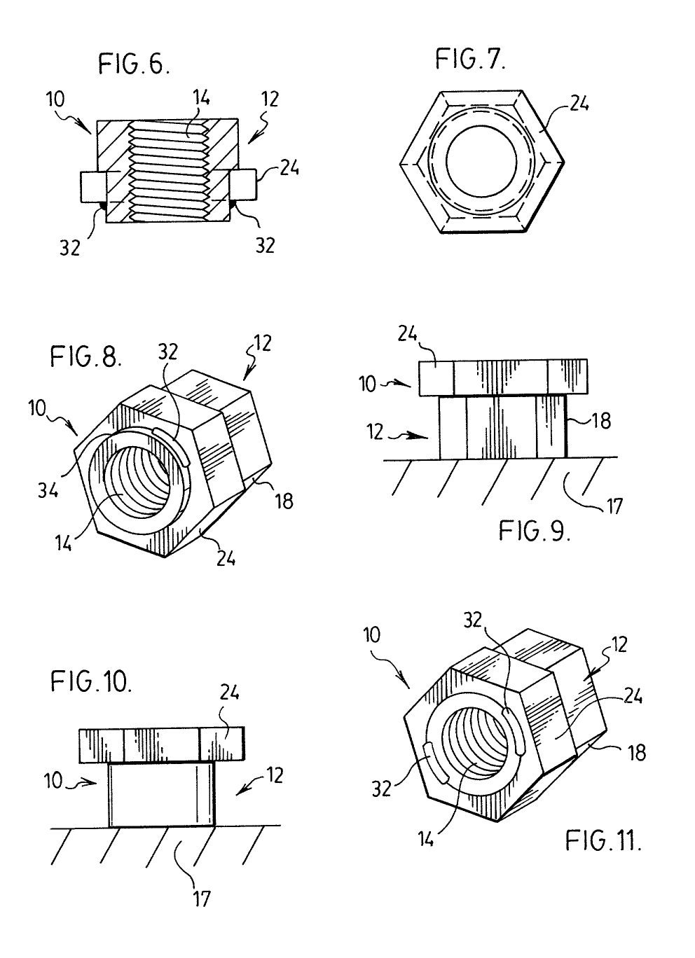

Having reference to FIGS. 1 and 2 illustrating the elements of the torque limiting device (generally designated by the numeral 10), prior to assembly, there is provided a torquing head 12 having a longitudinal, coaxial threaded bore 14 adapted to receive a threaded bolt 16. The threaded bolt 16, as shown in FIG. 3, forms no part of the present invention. Alternatively, a stud or the like may be utilized as the fastener. The torquing head 12 forms at its upper end an outwardly extending, circumferential collar 18, which in a first embodiment is hexagonal 18a in shape as illustrated in FIG. 1 and when assembled in FIG. 4. In a second embodiment, as shown in FIG. 2 and when assembled in FIG. 5, the collar 18 defines a smooth circumferential circular shape 18b. The lower section 20 of the torquing head 12 thus has a relatively smaller outer diameter than that of the upper collar 18. There is as a result, defined an outer circumferential lip 22 between collar 18 and lower section 20.

A lower hexagonal nut 24 forms a generally smooth coaxial inner bore 26. The bore 26 of the hexagonal nut 24 is sized to engage the outer circumference 28 of the lower section 20 of torquing head 12. Once assembled, the upper face 30 of the hexagonal nut 24 is in abutment with the outer circumferential lip 22 of the torquing head 12. The hexagonal nut 24 functions to provide the torquing mechanism whereby the torquing head 12 may be installed.

The torquing head 12 and the hexagonal nut 24 may be manufactured from steel or stainless steel or any suitable material.

Having particular reference to FIGS. 2, 5, and 10 wherein the torquing head 12 is provided with a smooth surfaced outer collar 18a it is to be noted that advantageously a smaller hexagonal nut 24 than that utilized where the collar 18 has an outer hexagonal shape may be used.

At least two laser welds 32 are utilized to interconnect the torquing head 12 to the hexagonal nut 24 thereby forming the torque limiting device 10 of the present invention. The use of one laser weld yields a gradual and inconsistent torque value, whereas two diametrically-opposed welds, or three or more equispaced welds, give a sudden shear with consistent torque values. The laser weld or welds 32 must be applied where the inner part 34 of the hexagonal nut 24 contacts the lower section 20 of the torquing head 12, the upper face of the hexagonal nut 24, as stated previously, being in abutment with the outer circumferential lip 22. Preferably, two diametrically-opposed laser welds 32 would be utilized, but three, four or more equispaced laser welds can be used. The laser welds 32 provide the precise, desired, torque shear values.

FIGS. 9, 10 and 11 are illustrative of third and fourth embodiments of the torque limiting device 10. More specifically, the torquing head 12 and hexagonal nut 24, once assembled are substantially flush at the base thereof. The laser weld(s) 32 are provided at similar locations described earlier for the first and second embodiments.

In operation the torque limiting device 10 is torqued onto a fastener 16 which may be a threaded bolt, stud or the like, by engagement of a wrench with the outer wall of the hexagonal nut 24 until the desired torque shear value of the laser weld(s) is reached causing shearing thereof. Thereupon, the hexagonal nut 24 rotates freely about the torquing head 12.

It will be noted that due to the provision of an inner bore 14 of uniform diameter which extends the length of the torque limiting device 10, the embodiments shown in FIGS. 1 and 2 are installable in either direction, whereas the embodiments shown in FIGS. 9 and 10 can be installed only with the hexagonal nut 24 distal to the base 17.

It will be apparent that, while presently preferred embodiments of the invention are described herein, variations and modifications will occur to those skilled in the art and should not be considered as departing from the spirit of the invention.

I claim:

1. A torque limiting device adapted for use with a fastener which comprises:
a first member defining an internally threaded, longitudinal bore coaxial therewith, said bore being adapted to receive said fastener therein, said first member forming at one end a collar having a greater outer diameter than its opposite end thereby defining a circumferential lip therebetween;
a second hexagonal member defining a smooth inner bore coaxial therewith, said bore being adapted to engage and receive the opposite end of said first member therein whereby a face of said hexagonal member lies in abutment with said circumferential lip and said collar extends above said hexagonal member; and
shear means adapted to interconnect said first and second members, said shear means comprising at least two equispaced laser welds interconnecting at least a portion of the area of said hexagonal member with at least a portion of an adjacent section of said first member whereby said laser welds are functional to shear at a predetermined torque shear strength, thereby eliminating both under and over torquing of said torque limiting device.

2. The torque limiting device as set forth in claim 1 wherein said shearing means comprises two diametrically opposed laser welds.

3. The torque limiting device as set forth in claim 2 wherein said collar forms an outer hexagonal wall.

4. The torque limiting device as set forth in claim 2 wherein said collar forms a smooth, circular outer wall.

5. The torque limiting device as set forth in claim 3 wherein the opposite end of said first member extends beyond said hexagonal member.

6. The torque limiting device as set forth in claim 4 wherein the opposite end of said first member extends beyond said hexagonal member.

7. The torque limiting device as set forth in claim 3 wherein the opposite end of said first member lies in the same plane as the base of said hexagonal member.

8. The torque limiting device as set forth in claim 4 wherein the opposite end of said first member lies in the same plane as the base of said hexagonal member.
